(19) United States
(12) Patent Application Publication
(10) Pub. No.: US 2014/0015496 A1
(43) Pub. Date: Jan. 16, 2014

(54) CHARGING DEVICE

(71) Applicants: Tadao Nishiguchi, Aichi (JP); Takashi Yamada, Gifu (JP); Hideyuki Yasugi, Aichi (JP); Masayuki Hanatani, Aichi (JP); Yusaku Ido, Gifu (JP)

(72) Inventors: Tadao Nishiguchi, Aichi (JP); Takashi Yamada, Gifu (JP); Hideyuki Yasugi, Aichi (JP); Masayuki Hanatani, Aichi (JP); Yusaku Ido, Gifu (JP)

(73) Assignee: OMRON AUTOMOTIVE ELECTRONICS CO., LTD., Aichi (JP)

(21) Appl. No.: 13/933,458

(22) Filed: Jul. 2, 2013

(30) Foreign Application Priority Data
Jul. 2, 2012 (JP) 2012-148916

(51) Int. Cl. H02J 7/00

(52) U.S. Cl. CPC H02J 7/007
USPC 320/162

(57) ABSTRACT

A charging device has an AC power supply input part that rectifies an AC voltage, a power factor correction part that converts a rectified voltage outputted from the AC power supply input part into a DC intermediate voltage, a power conversion part that converts the intermediate voltage outputted from the power factor correction part into a charge voltage, and supplies the charge voltage to a secondary battery, an input voltage acquisition unit that acquires the rectified voltage outputted from the AC power supply input part, an output voltage acquisition unit that acquires the charge voltage outputted from the power conversion part, and a storage part in which the rectified voltage, the charge voltage, and a target intermediate voltage correlated with the rectified voltage and charge voltage are stored.

### BACKGROUND

1. Technical Field

The present invention relates to a charging device, particularly to a charging device including a power factor correction circuit that converts an AC voltage into a DC voltage and a voltage conversion circuit that converts the DC voltage from the power factor correction circuit into a predetermined DC voltage and supplies the predetermined DC voltage to a storage battery.

2. Related Art

Conventionally, a technology of converting the various predetermined AC input voltage into the DC output voltage and a technology of efficiently performing the conversion are well known in the charging device including the power factor correction circuit that converts the AC voltage into the DC voltage and the voltage conversion circuit that converts the DC voltage from the power factor correction circuit into the predetermined DC voltage and supplies the predetermined DC voltage to the storage battery.

For example, Japanese Unexamined Patent Publication No. 06-105545 discloses a worldwide input type switching power-supply device that has high efficiency for both the AC input voltages of a 100-V system and a 200-V system for the purpose of downsizing and cost reduction. In the switching power-supply device, an auxiliary resistor, a switch part, and a voltage detection circuit are provided in a base circuit part of a switching transistor instead of providing a conventional constant-voltage circuit. The auxiliary resistor and the switch part are connected in series with each other, and the auxiliary resistor and the switch part are connected in parallel with a base resistor. The voltage detection circuit detects whether the AC input voltage is the 100-V system or the 200-V system by a voltage on an output side of a diode connected to a base winding of a transformer. The voltage detection circuit turns on the switch part when the AC input voltage is the 100-V system, and the voltage detection circuit turns off the switch part when the AC input voltage is the 200-V system.

Japanese Unexamined Patent Publication No. 2008-099439 discloses a switching power-supply device in which a state of a PFC (Power Factor Correction) circuit is determined without setting an output voltage at the PFC circuit to a high voltage, whereby a low-withstand-voltage, inexpensive, and compact component can be used. The switching power-supply device includes the PFC circuit that corrects a power factor of a full-wave rectification output, a DC/DC converter that converts a DC output at the PFC circuit into another DC voltage and outputs the converted DC voltage, a control IC that controls a power factor correction operation of the PFC circuit, a digital controller that controls a DC/DC conversion operation of the DC/DC converter, and a detection circuit that detects the state of the PFC circuit. The digital controller determines the state of the PFC circuit controlled by the control IC from the detection of the detection circuit, and the digital controller controls start-up of the DC/DC converter based on the determination.

Japanese Unexamined Patent Publication No. 2009-213202 discloses a switching power-supply device that deals with the wide input voltage by a simple configuration. In the switching power-supply device, an insulated DC-DC converter includes a battery charging circuit in a secondary side circuit of a transformer. A drive circuit decreases a switching frequency of a switching element of a primary side circuit in the transformer of the insulated DC-DC converter in the case where an output voltage detection circuit that detects an output voltage of a power factor correction circuit detects a low output voltage at the power factor correction circuit. The drive circuit increases the switching frequency of the switching element of the primary side circuit in the transformer of the insulated DC-DC converter in the case where the output voltage detection circuit detects a high output voltage at the power factor correction circuit.

Japanese Unexamined Patent Publication No. 2010-041891 discloses a charger in which the power factor correction circuit is provided at an input stage of a voltage conversion device to enhance energy conversion efficiency in the case of the small DC output current. The charger includes the power factor correction circuit that converts the AC input voltage into the DC output voltage and the voltage conversion device that converts the DC output voltage at the power factor correction circuit into a predetermined DC charge voltage and supplies the predetermined DC charge voltage to a lead storage battery. The charger performs the control such that the DC output voltage at the power factor correction circuit is increased or decreased according to magnitude of s DC charge current supplied to the lead storage battery from the voltage conversion device.

### SUMMARY

One or more embodiments of the present invention provides a charging device that can efficiently convert the voltage by outputting the previously-acquired intermediate voltage having the maximum entire efficiency according to a voltage conversion characteristic of the charging device.

In accordance with one or more embodiments of the present invention, a charging device includes: an AC power supply input part that rectifies an AC voltage; a power factor correction part that converts a rectified voltage outputted from the AC power supply input part into a DC intermediate voltage; a power conversion part that converts the intermediate voltage outputted from the power factor correction part into a charge voltage, and supplies the charge voltage to a secondary battery; an input voltage acquisition unit that acquires the rectified voltage outputted from the AC power supply input part; an output voltage acquisition unit that acquires the charge voltage outputted from the power conversion part; a storage part in which the rectified voltage, the charge voltage, and a target intermediate voltage correlated with the rectified voltage and charge voltage are stored; and a controller that acquires the rectified voltage from the input voltage acquisition unit, acquires the charge voltage from the output voltage acquisition unit, acquires the target intermediate voltage from the storage part based on the acquired rectified voltage and charge voltage, and controls the power factor correction part such that the outputted intermediate voltage becomes the target intermediate voltage.

Therefore, the previously-acquired intermediate voltage having the maximum entire efficiency is outputted according to the voltage conversion characteristic of the charging device, so that the charging device that efficiently converts the voltage can be provided.

According to one or more embodiments of the present invention, the charging device may further include a target output voltage acquisition unit that acquires a target voltage at the secondary battery, wherein the controller acquires the target voltage from the target output voltage acquisition unit, and controls the power conversion part based on the charge voltage and the target voltage.

Therefore, the efficient charging device having the configuration in which the charge voltage close to the target voltage at the secondary battery is supplied to the secondary battery using the target output voltage can be provided.

As described above, according to one or more embodiments of the present invention, the previously-acquired intermediate voltage having the maximum entire efficiency can be outputted according to the voltage conversion characteristic of the charging device, so that the voltage can efficiently be converted.

### BRIEF DESCRIPTION OF THE DRAWINGS

FIG. 1 is a block diagram illustrating a charging device according to one or more embodiments of the present invention;

FIG. 2 is a circuit diagram of a power factor correction part in the charging device;

FIG. 3A is a circuit diagram illustrating a power conversion part and a controller in the charging device, and FIG. 3B is a view illustrating a waveform at a predetermined place;

FIG. 4 illustrates a table stored in a storage part of the charging device;

FIG. 5A is a circuit diagram illustrating a circuit that outputs intermediate voltages in the charging device, and FIG. 5B illustrates intermediate voltages that are obtained from a combination of resistance values and switches in the circuit (part 1);

FIG. 6A is a circuit diagram illustrating a circuit that outputs intermediate voltages in the charging device, and FIG. 6B illustrates intermediate voltages that are obtained from a combination of resistance values and switches in the circuit (part 2);

FIG. 7 is a flowchart illustrating control in the charging device; and

FIG. 8A is a flowchart illustrating a method for acquiring an input voltage in the charging device, and FIG. 8B is an explanatory view illustrating the method for acquiring the input voltage.

### DETAILED DESCRIPTION

Hereinafter, embodiments of the present invention will be described below with reference to the drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

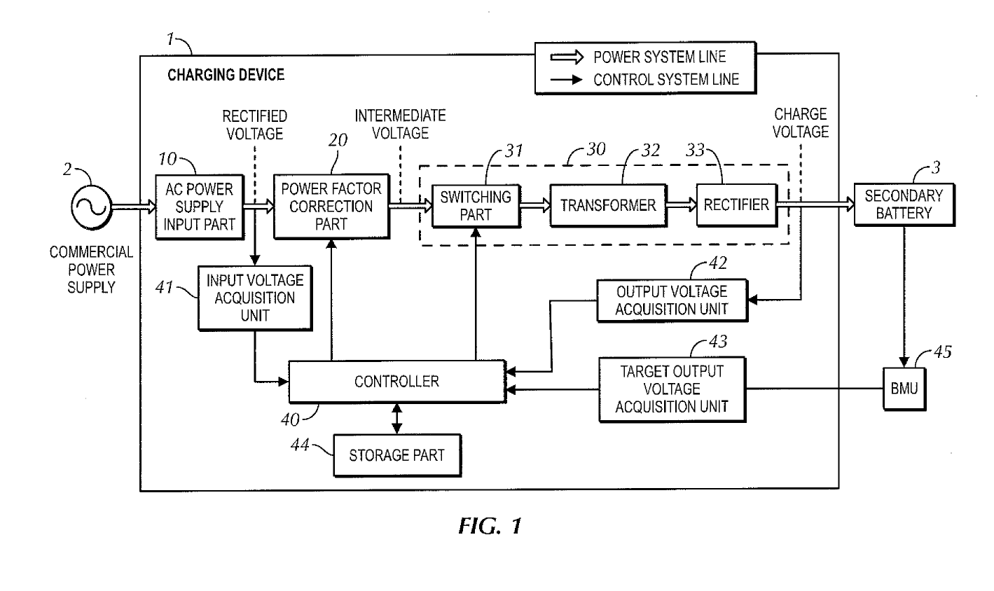

FIG. 1 is a block diagram illustrating a charging device 1 according to one or more embodiments of the present invention. The charging device 1 converts a power supplied from a commercial AC power supply 2, and charges a secondary battery 3. For example, the charging device 1 is used to charge a secondary battery (for example, a lithium-ion battery), which is mounted on an electric automobile or a plug-in hybrid type electric automobile, from the power distributed to each household. However, the use of the charging device 1 is not limited to the secondary battery.

The charging device 1 includes an AC power supply input part 10, a power factor correction part 20, and a power conversion part 30. The AC power supply input part 10 rectifies an AC voltage from the commercial AC power supply 2. The power factor correction part 20 converts a rectified voltage, which is rectified by and outputted from the AC power supply input part 10, into a DC intermediate voltage. The power factor correction part 20 improves an effective power quantity per unit time, which is part of a supply power quantity of the commercial AC power supply 2 and is stored in the secondary battery 3. The power conversion part 30 converts the intermediate voltage outputted from the power factor correction part 20 into a predetermined DC charge voltage, and supplies the DC charge voltage to the secondary battery 3 in order to charge the secondary battery 3.

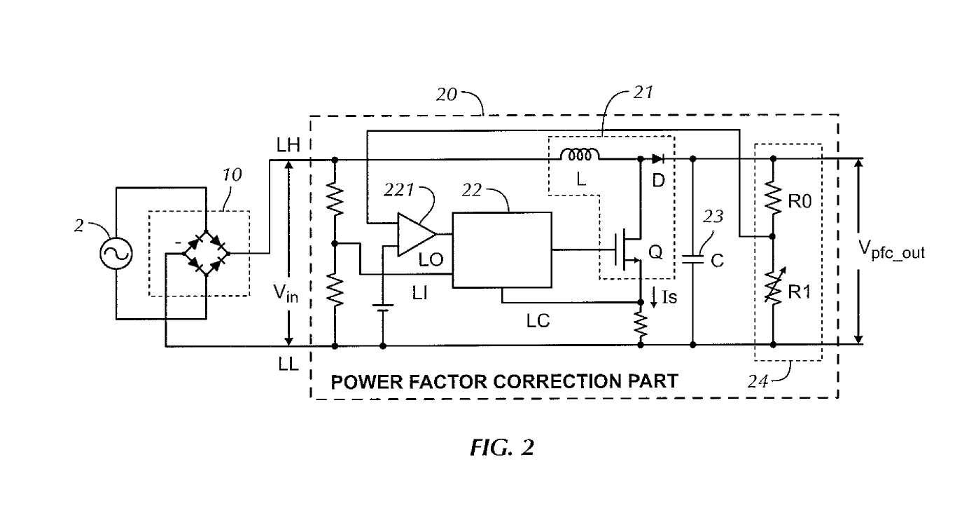

The AC power supply input part 10 and the power factor correction part 20 will specifically be described with reference to FIG. 2. The AC power supply input part 10 rectifies the AC voltage from the commercial AC power supply 2 as described above, and typically includes a diode bridge as illustrated in FIG. 2. The commercial AC power supply 2 is connected to an input side of the AC power supply input part 10, and a high side line LH and a low side line LL are connected to an output side. The AC power supply input part 10 performs full-wave rectification of a voltage waveform of the inputted AC power, and outputs the rectified voltage through the high side line LH and low side line LL. At this point, the rectified voltage is referred to as Vin.

The power factor correction part 20 includes a power factor correction switching circuit 21, a power factor correction controller 22, a stabilization circuit 23, and an intermediate voltage output part 24. The power factor correction switching circuit 21 includes a reactor L, a rectifying element D, and a switching element Q. The reactor L and the rectifying element D are provided in series on the high side line LH. One end of the switching element Q is connected to a connection point of the reactor L and an anode of the rectifying element D, and the other end is connected to the low side line LL.

The stabilization circuit 23 is a smoothing capacitor C that is connected to the high side line LH and low side line LL on a cathode side of the rectifying element D. In the power factor correction part 20, the power factor correction controller 22 properly drives the switching element Q to approximately match a phase of the full-wave rectification waveform in the inputted rectified voltage Vin with a phase of a current Is, which increasing an effective power quantity, and an intermediate voltage Vpfc_out can be obtained by boosting and smoothing the rectified voltage Vin.

The intermediate voltage output part 24 includes two series-connected resistors R0 and VR1, and the intermediate voltage Vpfc_out that is of the entire output of the power factor correction part 20 is divided at the connection point of the resistors R0 and VR1 to obtain the output of the intermediate voltage output part 24. The other terminal of the resistor RO is connected to the output side of the position at which the stabilization circuit 23 is connected to the high side line LH, and the other terminal of the resistor VR1 is connected to the output side of the position at which the stabilization circuit 23 is connected to the low side line LL. The resistor VR1 is a variable resistor that can control any voltage value. The detailed resistor VR1 is described later.

The power factor correction controller 22 is connected to a signal terminal of the switching element Q of the power factor correction switching circuit 21 and signal lines LI, LC, and LO. The power factor correction controller 22 acquires information on the voltage Vin outputted from the AC power supply input part 10 through the signal line LI. In one or more embodiments of the present invention, actually the power factor correction controller 22 acquires divided voltage. The power factor correction controller 22 acquires information on the current Is through the signal line LC. As used herein, the current Is means a current that returns to the commercial AC power supply 2 through the low side line LL.

The power factor correction controller 22 acquires information on the intermediate voltage Vpfc_{———}out through the signal line LO. Specifically, the power factor correction controller 22 acquires an error between the voltage divided at the connection point of the resistors R0 and VR1 of the intermediate voltage output part 24 and a reference voltage from an error amplifier 221 through the signal line LO. The power factor correction controller 22 drives the switching element Q based on a product of the rectified voltage Vin and the error. A switching cycle is as short as about one thousandth of a frequency of the commercial power supply. Therefore, a value of the rectified voltage Vin dealt with in each switching timing changes from moment to moment in conjunction with a voltage change of the commercial power supply. The current Is at a certain moment is controlled from the rectified voltage Vin at the moment by driving the switching element Q. For example, the current Is decreases, because the product decreases with decreasing rectified voltage Vin. On the other hand, the current Is increases, because the product increases with increasing rectified voltage Vin. Because the current Is is updated and controlled in conjunction with the change in the commercial power supply, the change in current Is suppresses a phase difference with respect to the rectified voltage Vin that moves in tandem with the voltage change of the commercial power supply. As a result, the power factor correction controller 22 corrects the power factor.

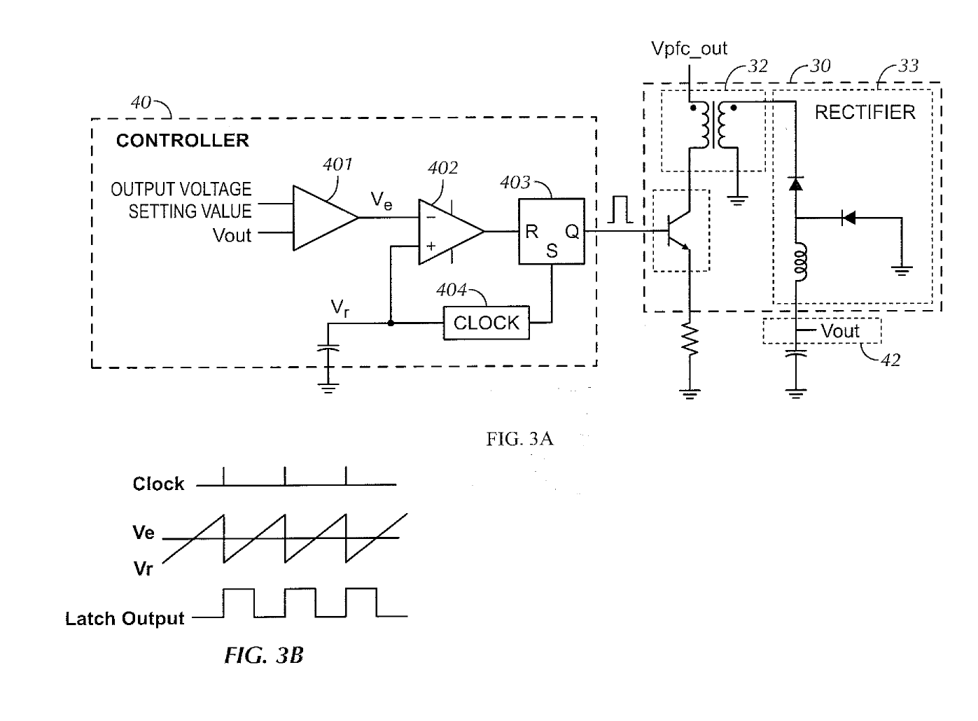

The power conversion part 30, an output voltage acquisition unit 42, and a controller 40 will be described below with reference to FIG. 3. One end of the power conversion part 30 is connected to the power factor correction part 20, and the other end is connected to the secondary battery 3. Based on a state of charge of the secondary battery 3, the power conversion part 30 boosts or steps down the intermediate voltage Vpfc_out outputted from the power factor correction part 20, and outputs a charge voltage Vout that is adjusted so as to fully charge the secondary battery 3.

The power conversion part 30 includes a switching part 31, a transformer 32, and a rectifier 33, which are located on a power system line. The transformer 32 receives an input of the intermediate voltage Vpfc_out from the power factor correction part 20, and properly boosts or steps down the voltage that is outputted by driving the switching part 31 controlled by the controller 40. The rectifier 33 rectifies the waveform of the boosted or stepped-down voltage, and supplies the rectified voltage to the secondary battery 3.

The output voltage acquisition unit 42 is a secondary side of the transformer 32, is provided at a subsequent stage of the rectifier 33, and acquires the charge voltage (Vout) that is outputted from the power conversion part 30 to the secondary battery 3.

The controller 40 includes a clock 404, and determines a duty ratio of a switching control waveform inputted to the switching circuit 31 from a voltage (Vr) that changes into a saw-tooth wave shape in synchronization with the clock 404 and the charge voltage (Vout) detected by the output voltage acquisition unit 42.

That is, the controller 40 inputs an externally-provided output voltage setting value to the error amplifier 401 while feeding back the charge voltage (Vout) detected by the output voltage acquisition unit 42 to an error amplifier 401, thereby detecting an error (Ve). Therefore, the controller 40 can control the charge voltage (Vout) such that the charge voltage (Vout) does not exceed the output voltage setting value.

The controller 40 inputs the error (ye) to a subsequent PWM comparator 402. The voltage (Vr) that changes in synchronization with the clock 404 is inputted to the other input terminal of the PWM comparator 402. Based on both the input values, the PWM comparator 402 modulates a pulse width of a latch output together with a latch 403.

As illustrated in FIG. 3B, the voltage (Vr) synchronized with the clock 404 repeats such motion that the voltage increases with time and is reset in synchronization with the clock 404. The switching control waveform outputted from the latch 403 changes from Low to High in synchronization with the clock 404. The switching circuit 31 is turned on in this timing. The switching control waveform outputted from the latch 403 changes from High to Low in timing when the voltage (Vr) exceeds the error (Ve). The switching circuit 31 is turned off in this timing.

Through the string of operations performed by the controller 40, for example, the switching duty ratio is sequentially adjusted and determined as follows. In the case where the error Ve increases because of the large error of the error amplifier 401, a time in which the voltage Vr reaches a level of the error Ve is lengthened. Therefore, a time in which the switching circuit 31 is turned on is lengthened to increase the switching duty ratio. On the other hand, in the case where the error Ve decreases because of the small error of the error amplifier 401, the time in which the voltage Vr reaches the level of the error Ve is shortened. Therefore, the time in which the switching circuit 31 is turned on is shortened to decrease the switching duty ratio.

The charging device 1 also includes an input voltage acquisition unit 41 located on a control system line. The input voltage acquisition unit 41 acquires the rectified voltage Vin outputted from the AC power supply input part 10. A method for acquiring the rectified voltage Vin with the input voltage acquisition unit 41 is described later.

The charging device 1 also includes a storage part 44 located on a control system line. The rectified voltage Vin, the charge voltage Vout, and the intermediate voltage Vpfc_out that is correlated with the rectified voltage Vin and charge voltage Vout are stored in the storage part 44. The storage part 44 includes a storage medium such as a memory and a disk, and a table is stored in the storage medium. The table has values of the intermediate voltage Vpfc_out that is correlated with the rectified voltage Vin and the charge voltage Vout.

The controller 40 acquires the rectified voltage Vin from the input voltage acquisition unit 41, and acquires the charge voltage Vout from the output voltage acquisition unit 42. The controller 40 also acquires the intermediate voltage Vpfc_out from the storage part 44 based on the acquired rectified voltage Vin and charge voltage Vout, and controls the power factor correction part 20 based on the acquired intermediate voltage Vpfc_out. Therefore, the previously-acquired intermediate voltage having the maximum entire efficiency is outputted according to a voltage conversion characteristic of the charging device, so that the voltage can efficiently be converted.

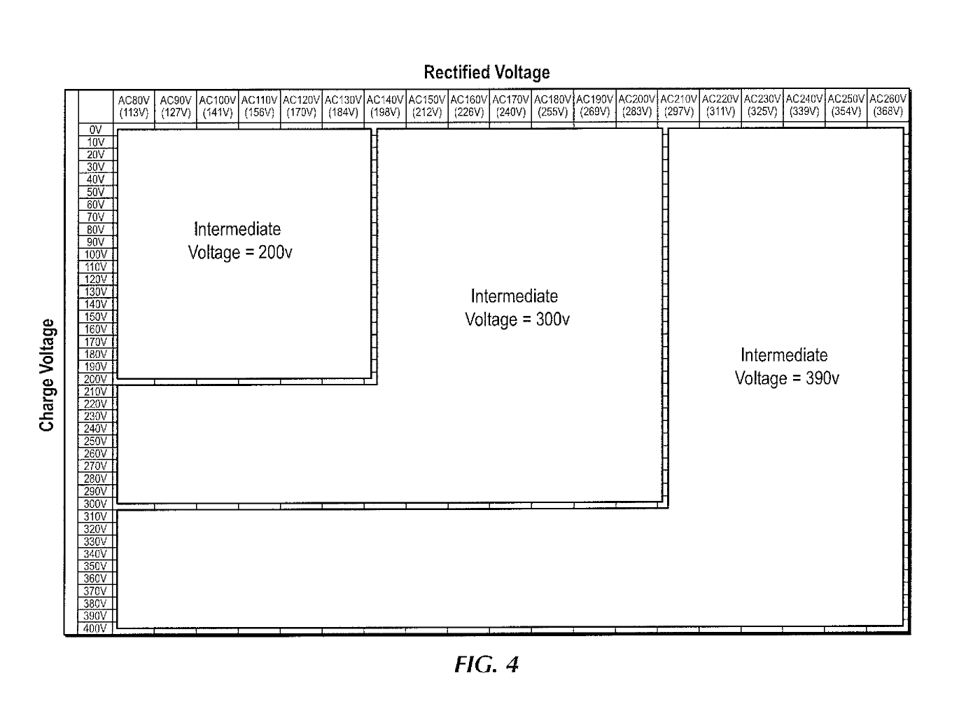

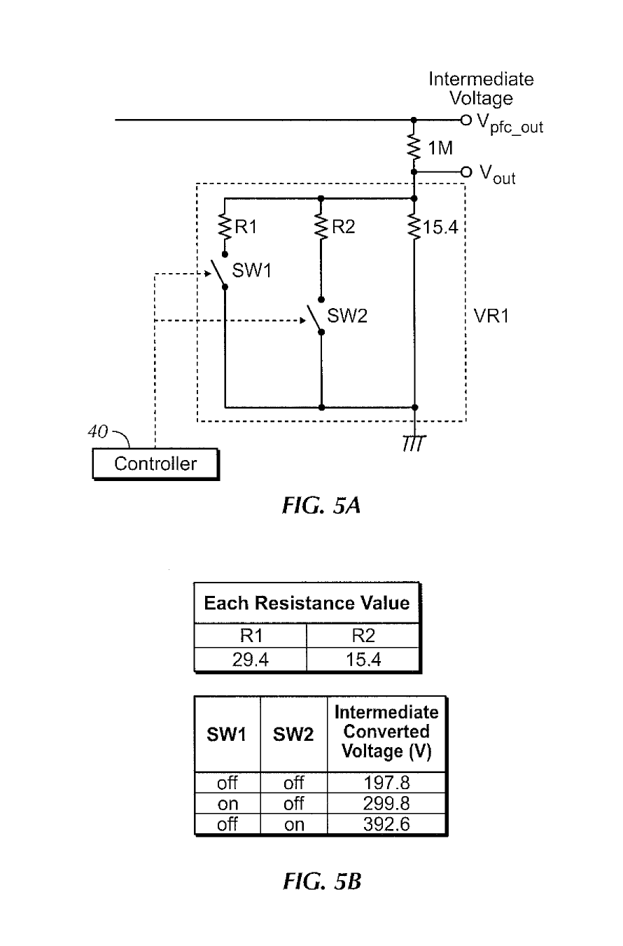

The table possessed by the storage part 44, a circuit diagram of the variable resistor VR1 of the intermediate voltage output part 24, and the intermediate voltage obtained by a combination of resistor values and switches in the circuit will specifically be described with reference to FIGS. 4 and 5. In the table in FIG. 4, a horizontal axis indicates the rectified voltage (Vin), a vertical axis indicates the charge voltage (Vout), and the intermediate voltage (Vpfc_out) is indicated at an intersecting portion. The intermediate voltage includes three values 200 V, 300 V, and 400 V. One intermediate voltage is defined so as to be substantially equal to or larger than the rectified voltage (specifically, a value multiplied by a square root of 2 that is the maximum value of the average rectified voltage) and the charge voltage. According to one or more embodiments of the present invention, the intermediate voltage in the table is one that has the maximum entire efficiency selected from an actual measurement result in each voltage conversion characteristic of the charging device.

The variable resistor VR1 having a circuit configuration in FIG. 5A according to the table in FIG. 4. That is, the variable resistor VR1 is constructed by two switches (SW1 and SW2) because the three values can be outputted, In the variable resistor VR1, resistance values are selected such that the voltages of 200 V, 300 V, and 400 V can be outputted.

Specifically, as illustrated in FIGS. 5A and 5B, the switch SW1 and the resistor R1 (29.4Ω) are connected in series, the switch SW2 and the resistor R2 (15.4Ω) are connected in series, and the switch SW1/resistor R1 and the switch SW2/resistor R2 are connected in parallel. The switches SW1 and SW2 and the resistors R1 and R2 are properly combined with the fixed resistor, and turn-on and turn-off of each of the switches SW1 and SW2 are also combined. Therefore, the outputs of three values can be obtained such that the output of 197.8 V, namely, about 200 V is obtained in the case where the switches SW1 and SW2 are turned off, such that the output of 299.8 V, namely, about 300 V is obtained in the case where the switch SW1 is turned on while the switch SW2 is turned off, and such that the output of 392.6 V, namely, about 400 V is obtained in the case where the switch SW1 is turned off while the switch SW2 is turned on.

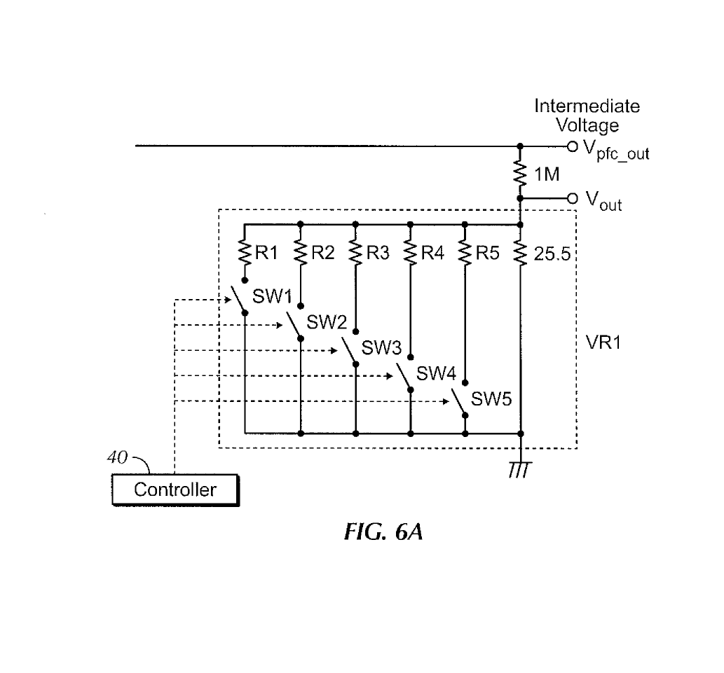

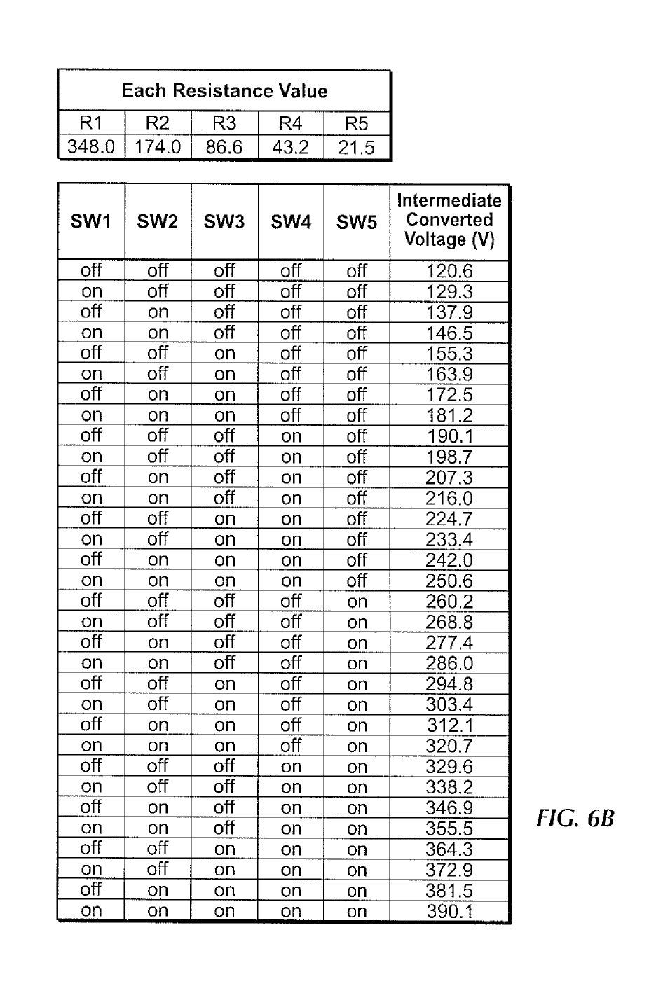

There is no particular limitation to the output values. The table in FIG. 4 has the three values of the intermediate voltages. However, the table has at least four values, and the control can be performed such that the voltage is more finely outputted. For example, as illustrated in FIG. 6A and 6B, when the circuit configuration includes five switches, the outputs of 32 (2⁵) ways can be performed, In the case where the variable resistor VR1 has the configuration, the table possessed by the storage part 44 can have the 32-step intermediate voltage.

Therefore, the charging device in which the voltage can efficiently be converted by selecting the previously-acquired intermediate voltage having the maximum entire efficiency according to the voltage conversion characteristic of the charging device can be provided.

The charging device 1 may further include a target output voltage acquisition unit 43 that acquires a target voltage at the secondary battery 3, The target output voltage acquisition unit 43 acquires the target value for the output of the charging device 1 from a BMU (Battery Management Unit) 45. The BMU 45 outputs the target value corresponding to the state (a charge amount) of secondary battery 3. Because the state of the secondary battery 3 changes sequentially during the charging operation, the BMU 45 outputs the optimum target value according to the change of the state of the secondary battery 3.

The controller 40 acquires the target voltage from the target output voltage acquisition unit 43, and drives the switching circuit 31 to control the power conversion part 30 based on the charge voltage and the target voltage. Therefore, the charge voltage close to the target voltage at the secondary battery 3 can be supplied to the secondary battery 3.

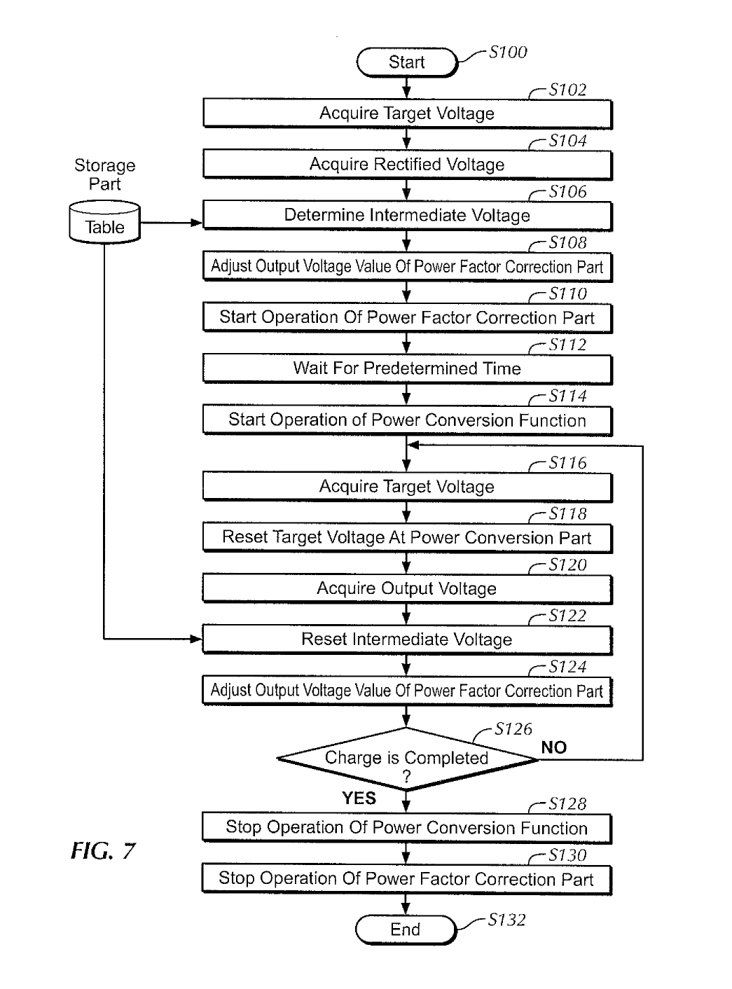

A flow of the control in the charging device 1 will be described with reference to FIG. 7. In the flowchart, each step is abbreviated to S. In S100, the charging device 1 is connected to the commercial AC power supply 2 to start the charge.

In S102, the target output voltage acquisition unit 43 acquires the output voltage value, which becomes the target value of the charge voltage used to charge the secondary battery 3, from the BMU 45. In S104, the input voltage acquisition unit 41 acquires the rectified voltage Vin outputted from the AC power supply input part 10.

In S106, based on the target charge voltage acquired in S102 and the rectified voltage acquired in S104, the controller 40 acquires the intermediate voltage that is correlated with the target charge voltage and rectified voltage from the table stored in the storage part 44, and determines the intermediate voltage value to be the intermediate voltage Vpfc_out outputted from the power factor correction part 20.

In S108, the power factor correction part 20 adjusts the variable resistor VR1 of the intermediate voltage output part 24 such that the voltage outputted from the power factor correction part 20 becomes the intermediate voltage Vpfc_out determined in S106.

In S110, the power factor correction controller 22 of the power factor correction part 20 drives the switching element Q of the power factor correction switching circuit 21 to start the operation of the power factor correction part 20. In S112, the charging device 1 waits for a predetermined time (about several hundreds milliseconds) necessary to stabilize the output voltage from the power factor correction part 20.

In S114, the controller 40 delivers the signal of the clock 404 to a Set of the latch 403, drives the switching circuit 31, and starts the function of the power conversion part 30.

In S116, the target output voltage acquisition unit 43 acquires the output voltage value, which becomes the target value of the charge voltage used to charge the secondary battery 3, from the BMU 45. In S118, according to the state of charge of the secondary battery 3, the controller 40 resets the optimum target charge voltage, which is acquired from the target output voltage acquisition unit 43 and should be outputted from the power conversion part 30.

In S122, in the case where the target output voltage acquisition unit 43 acquires the target charge voltage in S116, based on the target charge voltage acquired in S116 and the rectified voltage acquired in S104, the controller 40 acquires the intermediate voltage that is correlated with the target charge voltage and rectified voltage from the table stored in the storage part 44, and resets the intermediate voltage value to the intermediate voltage Vpfc_out outputted from the power factor correction part 20.

In the case where the target output voltage acquisition unit 43 does not acquire the target charge voltage in S116, the output voltage acquisition unit 42 acquires the charge voltage, which is outputted from the power conversion part 30 so as to fit for the target charge voltage value, in S120. In S122, based on the charge voltage and the rectified voltage acquired in S104, the controller 40 acquires the intermediate voltage that is correlated with the charge voltage and rectified voltage from the table stored in the storage part 44, and resets the intermediate voltage value to the intermediate voltage Vpfc_out outputted from the power factor correction part 20.

In S124, the power factor correction part 20 adjusts the variable resistor VR1 of the intermediate voltage output part 24 such that the voltage outputted from the power factor correction part 20 becomes the intermediate voltage Vpfc_out reset in S122.

The charging device 1 repeats the steps S116 to S124 until the secondary battery 3 is fully charged (S126). The state of charge is acquired from the BMU 45.

In the case where the secondary battery 3 is fully charged, the controller 40 stops the driving of the switching circuit 31 to stop the function of the power conversion part 30.

In S128, the power factor correction controller 22 stops the driving of the switching element Q of the power factor correction switching circuit 21 to stop the operation of the power factor correction part 20.

In S130, the charging device 1 cuts off the input from the commercial AC power supply 2.

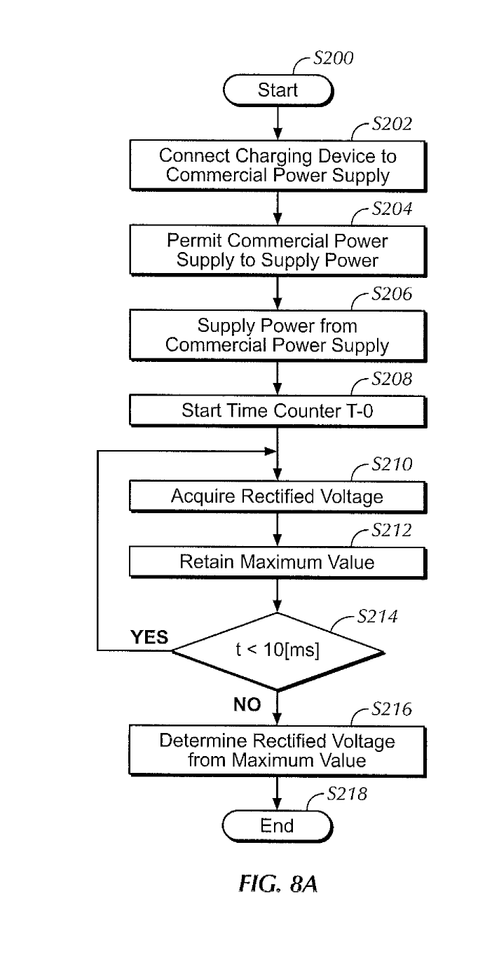

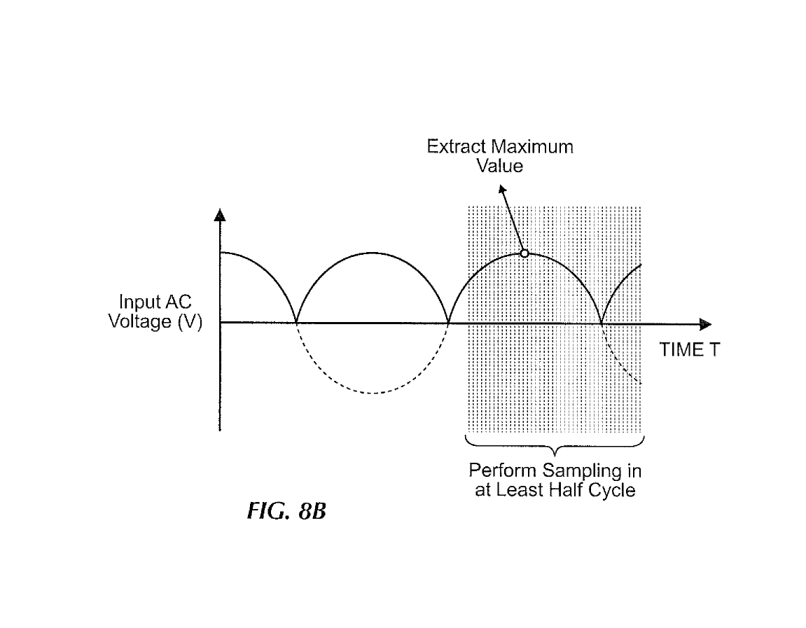

How the input voltage acquisition unit 41 acquires the rectified voltage Vin will be described with reference to FIG. 8A, In S202, the charging device 1 is connected to the commercial AC power supply 2. In S204, the AC power supply input part 10 permits the commercial AC power supply 2 to supply the power.

In S206, the commercial AC power supply 2 starts the supply of the power to the charging device 1 based on the permission obtained in S204. In S208, the charging device 1 sets a time counter (t).

The input voltage acquisition unit 41 acquires the rectified voltage outputted from the AC power supply input part 10 in S210, and retains the maximum voltage value in S212. The input voltage acquisition unit 41 repeats the steps S210 and S212 until the time counter (t) is less than 10 ms.

The description will be made with reference to FIG. 8B. The AC voltage received from the commercial AC power supply 2 by the charging device 1 is the waveform including a dotted line, while the rectified voltage outputted from the AC power supply input part 10 including the diode bridge becomes the solid-line waveform. The maximum voltage value is a vertex of a sinusoidal waveform, and the sinusoidal waveform is always obtained when sampling is performed in at least a half cycle of the sinusoidal waveform. Because usually the commercial AC power supply 2 is an alternating current of 50 Hz or 60 Hz, the maximum voltage value can always be acquired when the time counter is set to 10 ms. Accordingly, the time counter is properly adjusted in the case where the AC power supply having another frequency is used.

In S216, the input voltage acquisition unit 41 determines the average rectified voltage based on the maximum voltage value retained in S212. Usually the average voltage value is obtained by dividing the maximum voltage value by the square root of 2.

The present invention is not limited to the above embodiments, but various changes and modifications can be made without departing from the scope of the present invention. While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A charging device comprising:
an AC power supply input part that rectifies an AC voltage;
a power factor correction part that converts a rectified voltage outputted from the AC power supply input part into a DC intermediate voltage;
a power conversion part that converts the intermediate voltage outputted from the power factor correction part into a charge voltage, and supplies the charge voltage to a secondary battery;
an input voltage acquisition unit that acquires the rectified voltage outputted from the AC power supply input part;
an output voltage acquisition unit that acquires the charge voltage outputted from the power conversion part;
a storage part in which the rectified voltage, the charge voltage, and a target intermediate voltage correlated with the rectified voltage and charge voltage are stored; and
a controller that acquires the rectified voltage from the input voltage acquisition unit, acquires the charge voltage from the output voltage acquisition unit, acquires the target intermediate voltage from the storage part based on the acquired rectified voltage and the charge voltage, and controls the power factor correction part such that the outputted intermediate voltage becomes the target intermediate voltage.

2. The charging device according to claim 1, further comprising:
a target output voltage acquisition unit that acquires a target voltage at the secondary battery,
wherein the controller acquires the target voltage from the target output voltage acquisition unit, and controls the power conversion part based on the charge voltage and the target voltage.
